(19) United States
(12) Patent Application Publication
(10) Pub. No.: US 2012/0256867 A1
(43) Pub. Date: Oct. 11, 2012

(54) Underwater touchscreen system

(76) Inventor: William R. Annacone, Stowe, VT (US)

(21) Appl. No.: 13/066,206

(22) Filed: Apr. 9, 2011

(51) Int. Cl. G06F 3/044; G06F 3/041

(52) U.S. Cl. 345/174; 345/173

(57) ABSTRACT

A fluidic capacitive barrier includes at least one resiliently flexible clear membrane that holds a film or thin layer of clear liquid adjacent to a capacitive touchscreen display. The clear liquid has a dielectric constant that is much less than that of water, so the liquid layer provides a capacitive barrier between the touchscreen and a surrounding body of water. Pressing a finger against the flexible membrane locally displaces some of the liquid layer, which allows the touchscreen to sense the manual touch. Thus, the fluidic capacitive barrier makes the touchscreen functional underwater. In some examples, the clear liquid is mineral oil, and the membrane is made of thermoplastic polyurethane. In some examples, the fluidic capacitive barrier is part of a hermetically sealed enclosure in which a touchscreen device can be removably installed for underwater use. In other examples, the fluidic capacitive barrier is part of a touchscreen device itself.

### FIELD OF THE INVENTION

The subject invention generally pertains to touchscreens and more specifically to means for rendering a touchscreen functional underwater.

### BACKGROUND

Various waterproof enclosures have been developed for using digital devices underwater. Such enclosures, however, can limit the functionality of some devices, particularly those with capacitive touchscreen displays.

### BRIEF DESCRIPTION OF THE DRAWINGS

FIG. 1 is a cross-sectional side view similar to FIG. 4 but showing an example digital device installed within an example enclosure.

FIG. 2 is a cross-sectional side view similar to FIG. 2 but showing a finger actuating the touchscreen.

FIG. 3 is a cross-sectional side view taken along line 3-3 of FIG. 4.

FIG. 4 is a front view of FIG. 3.

FIG. 5 is a front view showing the digital device being inserted in the enclosure.

FIG. 6 is a front view similar to FIG. 4 but showing the digital device inside the enclosure.

FIG. 7 is an exploded perspective view of example membranes for the fluidic capacitive barrier shown in FIGS. 1-6.

FIG. 8 is a front view of the membranes of FIG. 7 but showing the membranes joined to each other.

FIG. 9 is a front view similar to FIG. 8 but showing the gap between the membranes filled with a fluid.

FIG. 10 is a cross-sectional side view showing two example membranes being joined.

FIG. 11 is a cross-sectional side view similar to FIG. 10 but showing a fluid being injected between the two joined membranes.

FIG. 12 is a cross-sectional side view similar to FIG. 11 but showing a needle perforation being sealed.

FIG. 13 is a cross-sectional side view similar to FIG. 11 but showing another method for injecting fluid between the two membranes.

FIG. 14 is a cross-sectional side view similar to FIG. 13 but showing the two membranes being sealed after removal of a fluid injector's needle.

FIG. 15 is a cross-sectional side view similar to FIG. 1 but showing an example digital device with a touchscreen and an integral fluidic capacitive barrier.

FIG. 16 is a cross-sectional side view similar to FIG. 15 but showing a finger actuating the touchscreen.

FIG. 17 is a cross-sectional side view similar to FIG. 3 but showing at least one of the membranes with a coating/layer.

### DESCRIPTION OF THE PREFERRED EMBODIMENT

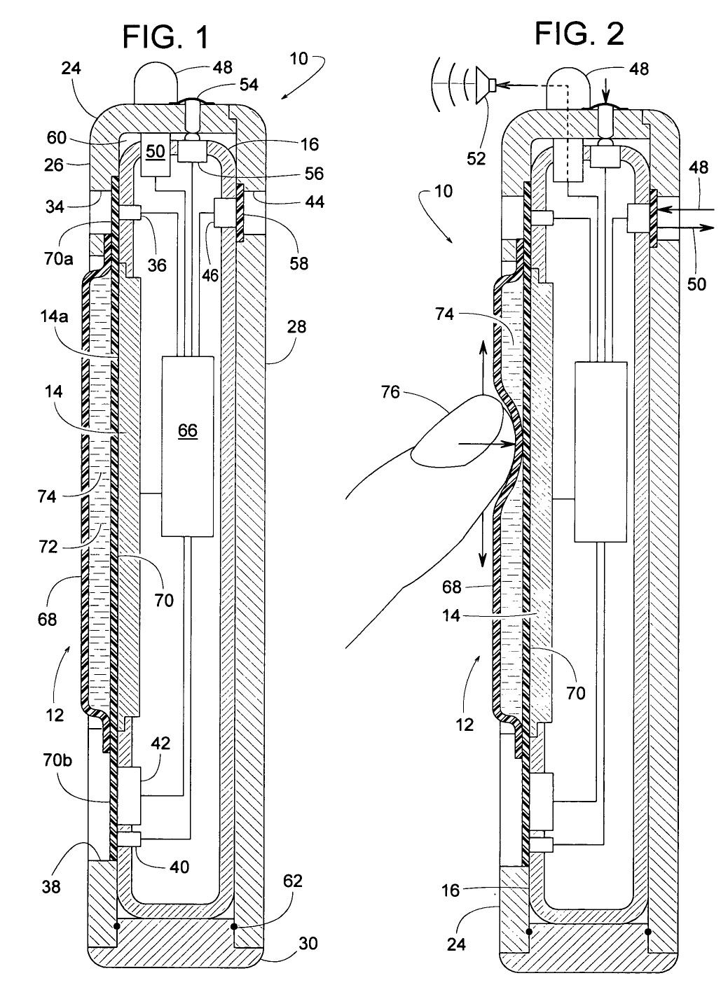

FIGS. 1-6 illustrate one example of a touchscreen system 10 that includes an example fluidic capacitive barrier 12 that allows an underlying touchscreen display 14 of a digital device 16 to be operated underwater. Digital device 16 is schematically illustrated to represent any piece of electronics. Examples of digital device 16 include, but are not limited to, a telephone, digital music player, camera, computer, tablet computer, computer monitor, personal digital assistant, video game player, PLC (programmable logic controller), GPS unit (global positioning system), IPHONE, IPOD, IPAD, etcetera. The terms, iPhone, iPod and iPad are registered trademarks of Apple, Inc. of Cupertino, Calif. Examples of digital device 16 include both portable and generally immobile devices. Some examples of a “telephone” include, but are not limited to, a cell phone, smartphone, satellite phone, etc.

The term, “touchscreen” means a visual display that not only displays information (e.g., letters 18, numbers 20, symbols 22, icons, maps, diagrams, photos, images, etc.) at a visual display area but also provides a means for receiving input by the visual display area being in physical contact or sufficient proximity with a manually movable external element (e.g., a human finger, stylus, pointer, wand, pen, and/or pencil, etc.). Some examples of system 10 are particularly useful when touchscreen 14 is a capacitive touchscreen display, wherein such a touchscreen is responsive to changes in capacitance in the vicinity of the touchscreen's display area. Examples of capacitive touchscreens include those that operate under known principles including, but not limited to, projected capacitance, mutual capacitance, and self-capacitance.

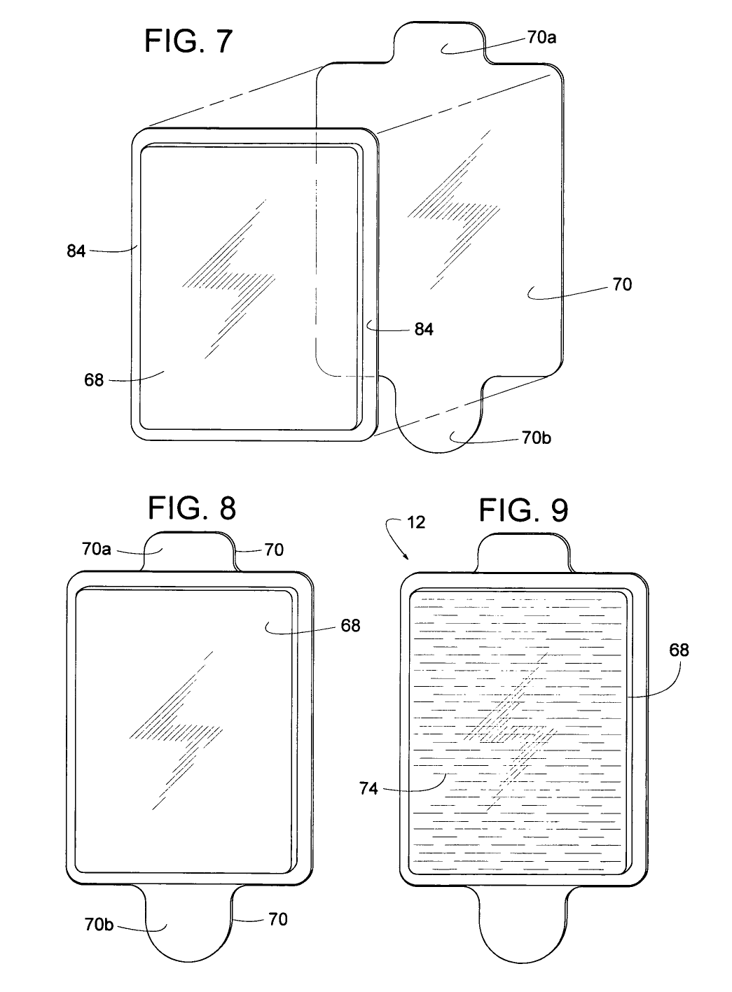

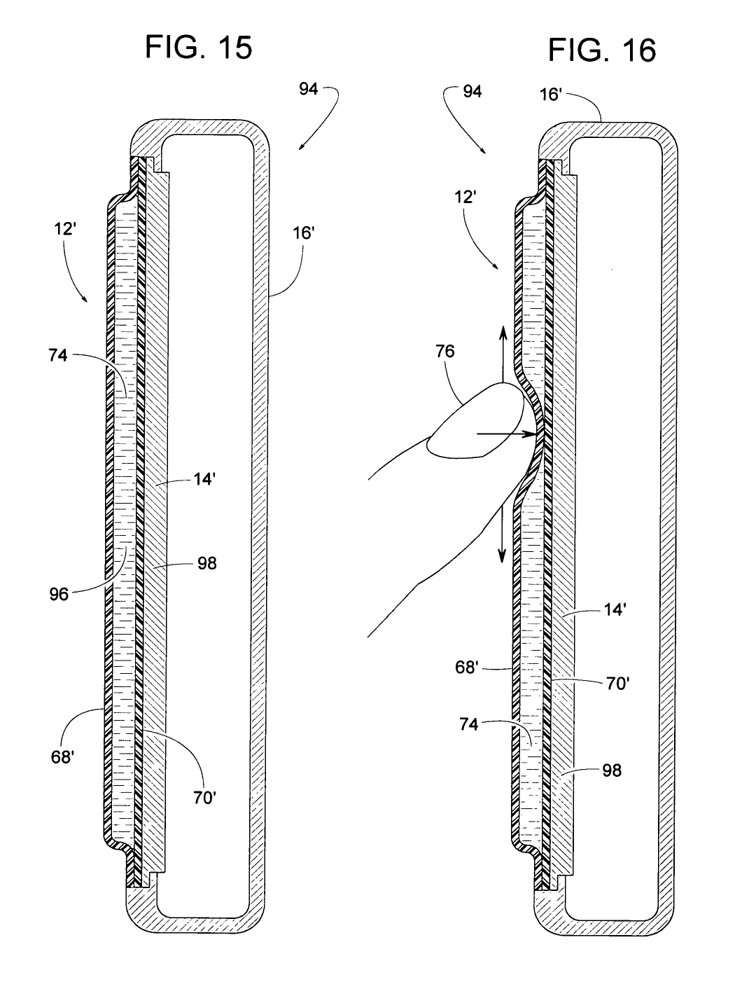

In some examples, submerging or exposing touchscreen 14 to water adversely affects the operation of touchscreen 14 by dramatically changing the capacitance in the area where touchscreen 14 is meant to be touched for input. To overcome this problem, some examples of system 10 include various examples of a fluidic capacitive barrier overlying a touchscreen. FIGS. 1-6 illustrate fluidic capacitive barrier 12, FIGS. 15 and 16 illustrate another example fluidic capacitive barrier 12′, and FIGS. 7-14 illustrate some example methods of making such fluidic capacitive barriers.

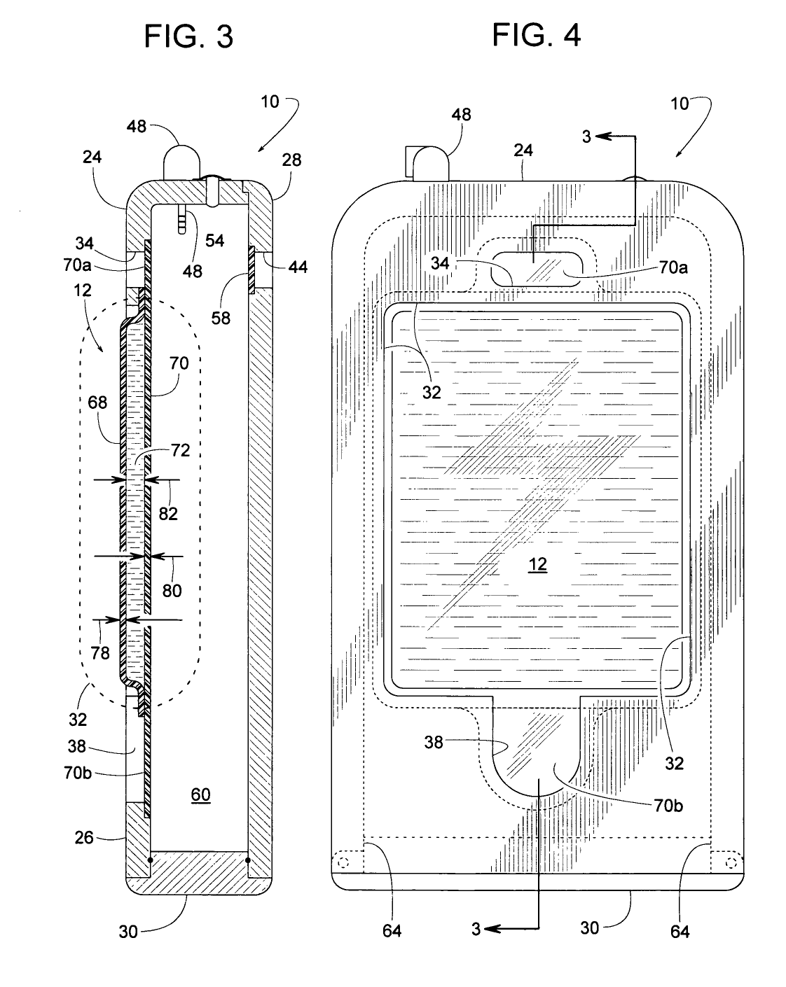

In the example shown in FIGS. 1-9, system 10 is shown housing digital device 16 within an enclosure 24 that includes fluidic capacitive barrier 12. Various examples of enclosure 4 are made of various example materials including, but not limited to, rigid plastic, rigid metal, pliable plastic (e.g., a bag, pouch, sack, etc.), transparent plastic, translucent plastic, opaque plastic, and various combinations thereof. Although the actual design of enclosure 24 may vary, in some examples, enclosure 24 comprises a main body 26, a back plate 28 and a hatch 30. Enclosure 24 defines a window area 32 (FIG. 3) for functional access to touchscreen 14 of digital device 16.

Enclosure 24, in this example, also includes various openings and/or “cutouts” to accommodate various functional elements of device 16. For example, a hole 34 in enclosure 24 can be used for an electrical element 36 (e.g., speaker, receiver, and/or a camera) of the illustrated device 16, a cutout 38 (e.g., a notch extending from window area 32) can be used for a microphone 40 and/or a pushbutton 42 (e.g., a “home button,” a rocker arm switch emulating a joystick, or a switch emulating a mouse click), and a fixed aperture 44 can be used for a camera 46 that employs one or more signals 48 and 50 (e.g., an image, a light sensing signal, range sensing signal, etc.).

For the illustrated example, enclosure 24 includes a hermetically sealed electrical connection 48 for connecting a headset jack 50 of device 24 to external headphones 52. Enclosure 24 also includes a hermetically sealed actuator 54 for actuating an on/off switch 56 of device 24.

In this example, main body 26 and back plate 28 begin as separate pieces to facilitate the manufacture of enclosure 24 by conventional plastic injection molding; however, main body 26 and back plate 28 are subsequently joined hermetically. A clear lens 58 (e.g., flat or curved, rigid or flexible) hermetically closes aperture 44, and generally peripheral portions of fluidic capacitive barrier 12 hermetically close off window area 32, hole 34, and cutout 38. In some examples, enclosure 24 is transparent and lens 58 is an integrally formed feature thereof.

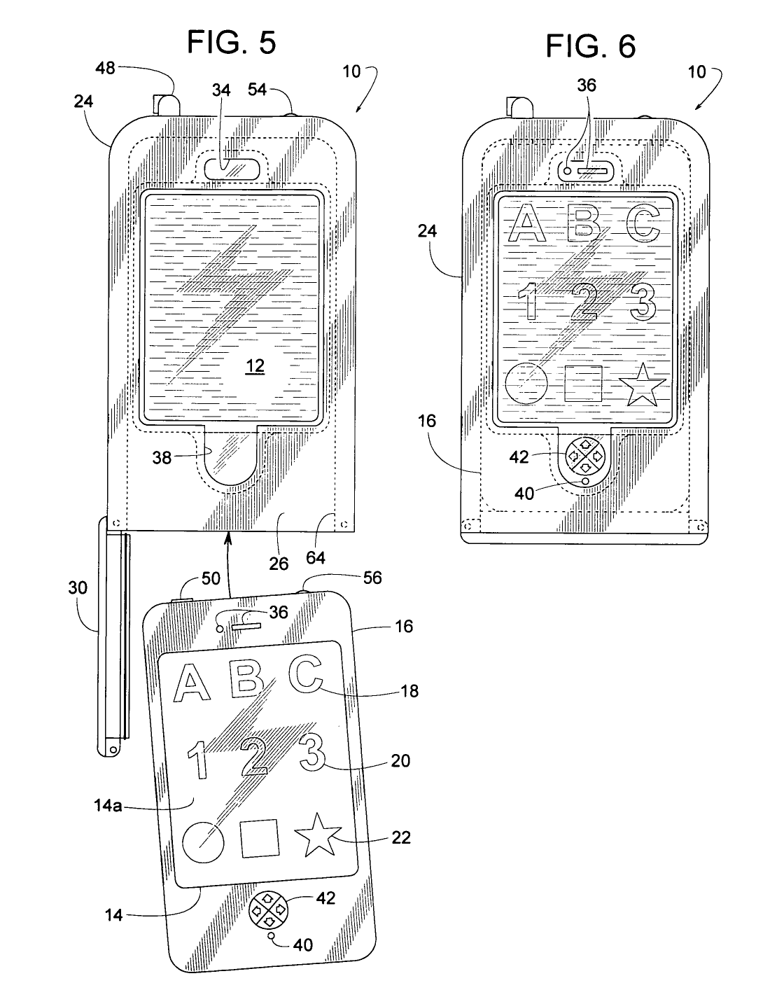

Hatch 30 for installing and removing device 16 from within an internal space 60 of enclosure 24 is shown in FIGS. 5 and 6. Hatch 30 includes a seal 62 (e.g., gasket, O-ring, press-fit, etc.) for hermetically sealing an access opening 64 (FIG. 4) of enclosure 24. When hatch 30 is closed, as shown in FIGS. 1-4 and 6, internal space 60 is hermetically sealed from the exterior of enclosure 24. The term, “hermetically” means that liquid water is substantially blocked against appreciable leakage when subjected to a pressure differential of about 0.01 kg/cm.

It may be worth noting that device 16 includes some appropriate conventional powered electrical circuit 66 (e.g., a microprocessor, an IC integrated circuit, circuit board, etc.) that coordinates, controls, and/or powers the operation of touchscreen 14 and the various other electrical elements of device 16. When device 16 is disposed within internal space 60 of enclosure 24, the device's touchscreen display 14 is generally aligned with and adjacent to window area 32 such that fluidic capacitive barrier 12 is adjacent to touchscreen 14.

In some examples, fluidic capacitive barrier 12 comprises an outer membrane 68, an inner membrane 70 and a gap 72 therebetween. When touchscreen system 10 is immersed in water (e.g., salt water, fresh water, chlorinated water, lake, swimming pool, ocean, etc.), a fluid 74 hermetically sealed within gap 72 is such that barrier 12 reduces a detrimental capacitive effect that the surrounding water touching barrier 12 would otherwise have on the function of touchscreen 14. Given water with a dielectric constant of about 30 to 80 (depending on its temperature and mixture with other elements), it has been discovered that examples of fluid 74 having a dielectric constant significantly less than 15 allows system 10 to function underwater in that touchscreen 14 can generally identify, for example, where a person's finger 76 is touching barrier 12 with sufficient force to bring membranes 68 and 70 in localized contact at finger 76, as shown in FIG. 2. In some examples, outer membrane 68 is resiliently flexible such that after being deflected, as shown in FIG. 2, outer membrane 68 resiliently returns to its unstressed state shown in FIG. 1. In some examples, fluid 74 is hermetically sealed within gap 72, and gap 72 is of a substantially fixed volume regardless of whether manual finger pressure is exerted against outer member 68. In such examples, fluid 74 is completely encapsulated between membranes 68 and 70 with no need for a pump to convey fluid 74 in or out from within gap 72.

In some examples, fluid 74 includes a liquid (or some other generally incompressible fluid) so that surrounding water pressure from within a swimming pool, for example, will not likely compress fluid 74 to the extent that the water pressure alone pushes membrane 68 against membrane 70. In some examples, fluid 74 is part of a paste or gel (e.g., a silicone gel) interposed between membranes 68 and 70. In some examples, fluid 74 includes a mineral oil to provide fluid 74 with a dielectric constant of about 2.5 (actual value may vary depending on the concentration of mineral oil, e.g., pure mineral oil or a significant percentage of mineral oil). The term, “dielectric constant” as used in this patent refers to a material or fluid's static relative permittivity (frequency of zero). Unless otherwise specifically stated, values of dielectric constants of various fluid 74 examples mentioned herein will be with reference to the example fluid 74 being at 25 degrees Celsius. In some examples, fluid 74 includes a silicone oil to provide fluid 74 with a dielectric constant of about 2.7 (actual value may vary depending on the concentration of silicone, e.g., pure silicone or a significant percentage of silicone). In some examples, fluid 74 is a non-crystalline liquid, i.e., not a liquid crystal.

In some examples, fluid 74, inner membrane 70 and outer membrane 68 are substantially transparent. The term, “substantially transparent’ means that one can see through at some of it to view at least some of touchscreen 14. Some examples of substantially transparent liquid and substantially transparent membranes are tinted. Some examples of substantially transparent membranes are polarized. Some examples of substantially transparent membranes include opaque areas (e.g., areas with some printing or decals thereon).

In some examples, membranes 68 and 70 and/or fluid 74 are translucent or opaque. In such examples, an image is printed or projected on outer membrane 68, wherein the printed or projected image generally coincides with and/or represents the underlying image displayed on touchscreen 14.

Although membranes 68 and 70 can be made of various materials, making membranes 68 and 70 of thermoplastic polyurethane works particularly well. Variations in membrane material thicknesses (dimensions 78 and 80) and variations in gap dimension 82 are possible; however, it has been discovered that a generally good design is when gap 72 (gap dimension 82) is greater than 0.8 mm, and membranes 68 and 70 each have a material thickness of less than 0.8 mm. In some examples, gap dimension 82 is about 2 mm, material thickness 78 of outer membrane 68 is about 0.25 to 0.41 mm, and material thickness 80 of inner membrane 70 is about 0.25 to 0.41 mm.

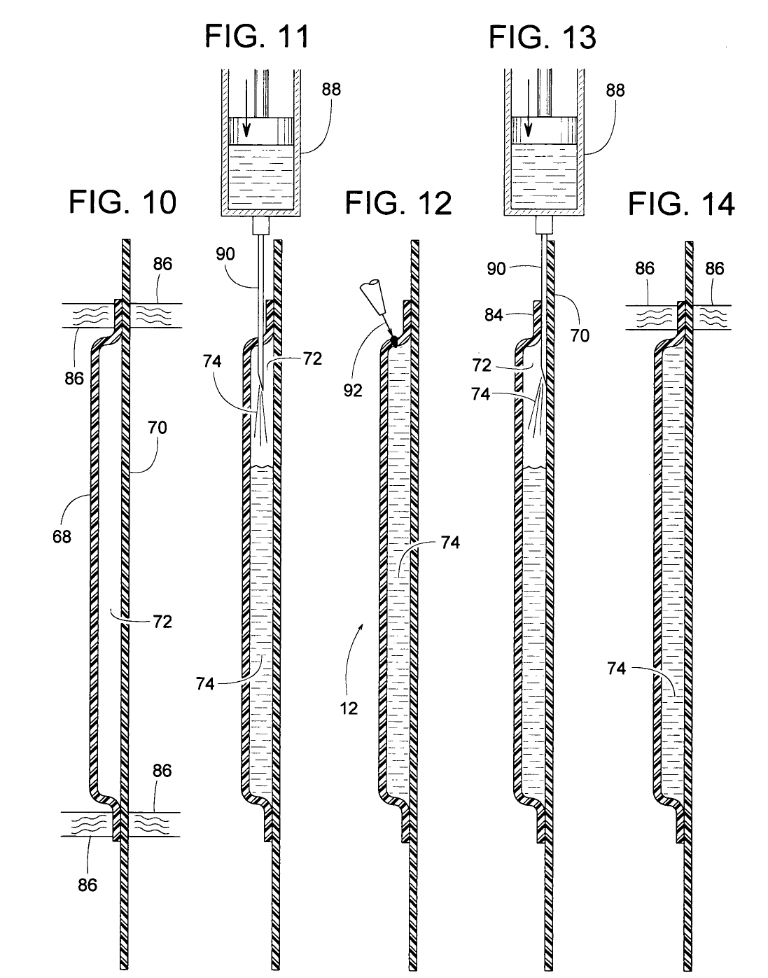

FIGS. 7-14 show examples of various construction and assembly details. Referring to FIGS. 7-9, in some examples, outer membrane 68 is vacuum formed (or otherwise molded or formed) so as to create gap 72 when a peripheral flange 84 of outer membrane 68 is subsequently bonded to inner membrane 70, wherein inner membrane 70 is relatively flat. Examples of bonding the outer membrane's flange 84 to inner membrane 70 include, but are not limited to, ultrasonic welding, heating, gluing, and/or combinations thereof. Items 86 of FIGS. 10 and 14 schematically illustrate the methods of ultrasonic welding and heating.

After membranes 68 and 70 are joined, as shown in FIG. 8, gap 72 is filled with fluid 74, thereby creating fluidic capacitive barrier 12, as shown in FIG. 9. One example method of filling gap 72 is shown in FIGS. 11 and 12. FIG. 11 shows a pressurized fluid injector 88 with a needle nozzle 90 piercing outer membrane 68 to inject fluid 74 in gap 72. After gap 72 is substantially filled with fluid 74 and needle 90 is removed from within gap 72, any resulting needle perforation is sealed by heat and/or a sealant, both of which are schematically illustrated by item 92 of FIG. 12.

One alternative to piercing outer membrane 68 is to ultrasonically weld the outer membrane's flange 84 to inner membrane 70 while needle 90 is between flange 84 and inner membrane 70, as shown in FIG. 13. After injector 88 fills gap 72 with fluid 74, needle 90 is extracted, and the area where the needle was situated is subsequently sealed, as indicated by item 86 of FIG. 14. In the fluid filling examples of FIGS. 11 and 13, gap 72 is vented in some convenient manner to allow air displaced by fluid 74 to escape from within gap 72. Examples of such venting include, but are not limited to, needle 90 having one or more external longitudinal flutes for conveying air, having the needle perforation be larger than the outside diameter of needle 90, and one of membranes 68 or 70 having a vent hole that is subsequently sealed shut.

In another assembly method example, membranes 68 and 70 lie horizontally while being joined, wherein outer membrane 68 is underneath inner membrane 70. Such an arrangement allows outer membrane 68 to be filled with a pool of fluid 74 prior to joining inner membrane 70 to the outer membrane's flange 84.

Once membranes 68 and 70 are joined and gap 72 is filled with fluid 74, the resulting fluidic capacitive barrier 12 of FIG. 9 is bonded or otherwise attached to enclosure 24, as shown in FIGS. 3 and 4, whereby membranes 68 and 70 become supported by enclosure 24. Upon attaching fluidic capacitive barrier 12 to enclosure 24, tabs 70a and 70b of inner membrane 70 provide a beneficially thin covering for hole 34 and cutout 38. The material thinness of tabs 70a and 70b (e.g., tabs 70a and 70b being about 0.25 to 0.41 mm thick) provide minimal interference (e.g., minimal optical interference, minimal mechanical interference, and/or minimal audio interference) with adjacent operating elements of digital device 16, yet tabs 70a and 70b are still able to hermetically seal those areas of enclosure 24.

In some examples, a touchscreen system 94 comprises a digital device 16′ that includes an integral fluidic capacitive barrier 12′, as shown in FIGS. 15 and 16. In this example, touchscreen system 94 comprises digital device 16′ with a capacitive touchscreen display 14′ borne by digital device 16′. Barrier 12′ includes an outer membrane 68′ in proximity with the capacitive touchscreen display 14′. Outer membrane 68′ creates a gap 96 somewhere between outer membrane 68′ and capacitive touchscreen display 14′. A non-crystalline liquid (e.g., liquid 74) is disposed within gap 96 somewhere between outer membrane 68′ and capacitive touchscreen display 14′. The non-crystalline liquid (e.g., liquid 74) has a dielectric constant (i.e., relative static permittivity) of less than 15 at 25 degrees Celsius.

Some examples of system 94 further include an inner membrane 70′ interposed between outer membrane 68′ and capacitive touchscreen display 14′, wherein gap 96 and the non-crystalline liquid (e.g., liquid 74) is interposed between membranes 68′ and 70′. Alternatively and/or in addition to this example, touchscreen display 14′ comprises a liquid crystal element 98 disposed outside of gap 96, as shown in FIGS. 15 and 16.

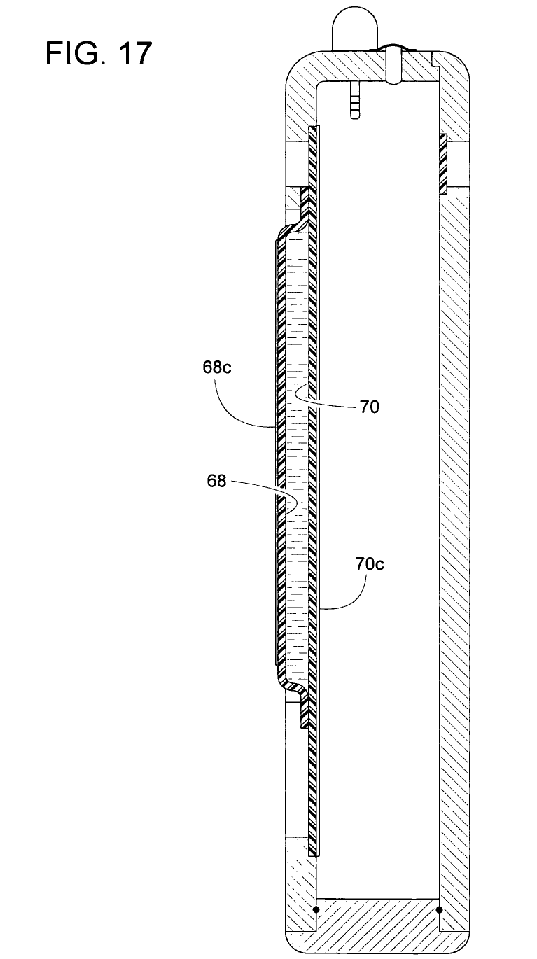

In the example shown in FIG. 17, at least one membrane 68 and/or 70 includes a coating or layer of material, such as layer 68c or 70c respectively. Such layers can provide one or more benefits, examples of which include, but are not limited to, reduced friction, reduced glare, improved wear resistance, scratch resistance, etc. Reduced friction, for example, may occur between layer 70c and a front display face 14a (FIG. 1) of touchscreen 14, as touchscreen 14 is inserted or removed from within enclosure 24. Reduced friction might also occur between layer 68c and finger 76 sliding therealong. Example materials of layers 68c and/or 70c include, but are not limited to, polypropylene, polycarbonate, polyester, oil, silicone, powder, etc. In some examples, layers 68c and/or 70c are attached or applied to the base material of membranes 68 and 70 by various means, examples of which include, but are not limited to, co-extrusion, adhesive bonding, ultrasonic welding, spraying, dipping, etc. In some examples, layers 68c and/or 70c are simply laid against their respective membrane 68 or 70 without being positively bonded or joined thereto.

Although the invention is described with respect to a preferred embodiment, modifications thereto will be apparent to those of ordinary skill in the art. The scope of the invention, therefore, is to be determined by reference to the following claims:

1. A touchscreen system for underwater operation of a digital device that includes a touchscreen display, the touchscreen system comprising:
an enclosure defining an internal space sized to contain the digital device and the touchscreen display, the enclosure further defining a window area adjacent to the touchscreen display when the digital device is housed within the enclosure;
an inner membrane supported by the enclosure at the window area, the inner membrane being adjacent to the touchscreen display when the digital device is housed within the enclosure;
an outer membrane supported by the enclosure at the window area, the inner membrane and the outer membrane defining a gap therebetween, the outer membrane being sufficiently flexible to resiliently bend toward the inner membrane when manually forced to do so; and
a fluid disposed within the gap between the inner membrane and the outer membrane.

2. The touchscreen, system of claim 1, wherein the fluid includes a liquid.

3. The touchscreen system of claim 1, wherein the fluid is a non-crystalline liquid.

4. The touchscreen system of claim 1, wherein the fluid includes oil.

5. The touchscreen system of claim 1, wherein the fluid includes a mineral oil.

6. The touchscreen system of claim 1, wherein the fluid includes silicone.

7. The touchscreen system of claim 1, wherein the fluid is a liquid with a dielectric constant of less than 15 at 25-degrees Celsius.

8. The touchscreen system of claim 1, wherein at least one of the inner membrane and the outer membrane includes a thermoplastic polyurethane.

9. The touchscreen system of claim 1, wherein the outer membrane includes a thermoplastic polyurethane.

10. The touchscreen system of claim 1, wherein the gap between the inner membrane and the outer membrane is greater than 0.8 mm, and both the inner membrane and the outer membrane each have a material thickness of less than 0.8 mm.

11. A touchscreen system comprising:
an enclosure defining an internal space and a window area;
a digital device that includes a capacitive touchscreen display, the digital device being disposed within the internal space of the enclosure with the capacitive touchscreen display being adjacent the window area of the enclosure;
an inner membrane supported by the enclosure at the window area, the inner membrane being substantially transparent, the inner membrane being adjacent to the capacitive touchscreen display;
an outer membrane supported by the enclosure at the window area, the outer membrane being substantially transparent, the inner membrane and the outer membrane defining a gap therebetween, the outer membrane being sufficiently flexible to resiliently bend toward the inner membrane when manually forced to do so; and
a liquid disposed within the gap between the inner membrane and the outer membrane, the liquid being substantially transparent.

12. The touchscreen system of claim 11, wherein the liquid has a dielectric constant of less than 15 at 25-degrees Celsius.

13. The touchscreen system of claim 11, wherein the gap is of a substantially fixed volume.

14. The touchscreen system of claim 11, wherein the gap between the inner membrane and the outer membrane is greater than 0.8 mm, and both the inner membrane and the outer membrane each have a material thickness of less than 0.8 mm.

15. The touchscreen system of claim 11, wherein the digital device is a digital music player.

16. The touchscreen system of claim 11, wherein the digital device includes a camera.

17. A touchscreen system comprising:
a digital device;
a capacitive touchscreen display borne by the digital device;
an outer membrane in proximity with the capacitive touchscreen display, the outer membrane creating a gap between the outer membrane and the capacitive touchscreen display; and
a non-crystalline liquid disposed within the gap between the outer membrane and the capacitive touchscreen display, the non-crystalline liquid having a relative static permittivity of less than 15 at 25-degrees Celsius.

18. The touchscreen system of claim 17, further comprising an inner membrane interposed between the outer membrane and the capacitive touchscreen display, wherein the gap and the non-crystalline liquid is interposed between the outer membrane and the inner membrane.

19. The touchscreen system of claim 17, wherein the capacitive touchscreen display includes a liquid crystal element disposed outside the gap.

20. The touchscreen system of claim 17, wherein the gap is of a substantially fixed volume.
